(19) United States
(12) Patent Application Publication
(10) Pub. No.: US 2010/0221955 A1
(43) Pub. Date: Sep. 2, 2010

(54) CASSETTE HAVING INTERCHANGABLE REAR MATING CONNECTORS

(75) Inventors: PAUL JOHN PEPE, CLEMMONS, NC (US); SHELDON EASTON MUIR, WHITSETT, NC (US); RUSSELL BRUCE ADAMS, GREENSBORO, NC (US)

Correspondence Address: ROBERT J. KAPALKA;TYCO TECHNOLOGY RESOURCES, 4550 NEW LINDEN HILL ROAD, SUITE 140, WILMINGTON, DE, 19808, US

(73) Assignee: TYCO ELECTRONICS CORPORATION, BERWYN, PA (US)

(21) Appl. No.: 12/394,912

(22) Filed: Feb. 27, 2009

(51) Int. Cl. H01R 24/00

(52) U.S. Cl. 439/676

(57) ABSTRACT

A cassette includes a shell having a front and a rear. The shell has a plurality of plug cavities open at the front for receiving plugs therein. A contact subassembly is received within the shell. The contact subassembly has a circuit board with front and rear sides, and the contact subassembly has a plurality of contacts electrically connected to the circuit board and extending from the front side. The contacts are arranged in contact sets that are configured to mate with corresponding plugs. The contact subassembly has an electrical connector extending from the rear side, where the electrical connector is electrically connected to corresponding contacts. The cassette also includes an interface connector received within the shell that is mated with the electrical connector. The interface connector has a rear mating connector extending from the rear of the shell and is configured to mate with a mating connector.

### CROSS REFERENCE TO RELATED APPLICATIONS

This application is related to copending U.S. patent application titled “CASSETTE FOR A CABLE INTERCONNECT SYSTEM”, having docket number E-TO-00220 (958-170) and filed Feb. 27, 2009, the subject matter of which is herein incorporated by reference in its entirety.

### BACKGROUND OF THE INVENTION

The subject matter herein relates generally to cassettes, and more particularly, to cassettes that have interchangeable rear mating connectors.

Cable interconnect systems utilize connector assemblies to interconnect cables and components within the system. Known connector assemblies exist having multiple receptacles in a common housing, which provide a compact arrangement with multiple connection ports. Accordingly, such a connector assembly is referred to as a multiple port connector assembly. In some assemblies the receptacle connectors may be in the form of RJ-45 type modular jacks that establish mating connections with corresponding RJ-45 modular plugs. In connector assemblies, the housing has receptacle connectors one above the other, forming a plurality of receptacles in stacked arrangement, so-called “stacked jack” arrangements. The receptacles each have plug receiving cavities with electrical terminals arranged in a terminal array therein.

One application for such connector assemblies is in the field of electronic networks, where desktops or other equipment are interconnected to servers or other network components by way of sophisticated cabling. Such networks may have a variety of data transmission mediums including coaxial cable, fiber optic cable and telephone cable. One such network is an Ethernet network, which is subject to various electrical standards, such as IEEE 802.3 and others. Such networks have the requirement to provide a high number of connections, yet optimally requires little space in which to accommodate the connections. Another application for such connector assemblies is in the field of telephony, wherein the receptacles provide ports for connection with a telephone switching network of a telephone service provider, such as a regional telephone company or national telephone company.

Typically, connector assemblies used within cable interconnect systems provide the receptacle connectors, at a front mating interface for interfacing with front end cable assemblies, such as cables having modular plugs. The connector assemblies also include a rear mating interface for interfacing with back end cables. One type of rear mating interface for connector assemblies includes cables that are direct wired to the modular jacks and routed to another component within the system. Such types of connector assemblies suffer from problems associated with cable density and cable routing. Additionally, such types of connector assemblies are not easily rerouted to different components or different types of components to accommodate system changes. Additionally, when upgrading, repairing or replacing the cables, the entire connector assembly is taken apart. For example, it is not possible to just replace the rear mating interface of such connector assemblies, such as with new cables or different types of cables.

In typical connector assemblies, the rear mating interface for interfacing with back end cables includes a rear mating connector that is matable to a cable connector of the back end cable assembly. The rear mating connectors are typically permanently mounted to a common circuit board and electrically connected to the contacts of the receptacles. The rear mating connectors are presented at the rear of the connector assembly. The cable connector can be mated to and unmated from the rear mating connector, such as to replace the back end cable with a different back end cable. This type of connector assembly suffers from the problem of requiring the same type of back end cable to be connected to the rear mating connector. Upgrades to the system are made difficult, such as when a system upgrade from copper cables to fiber optic cables, or vice versa, or from one type of cable connector to a different type of cable connector is desired. To accomplish such a change, the connector assembly needs to be removed (e.g. removing the modular plugs from the front mating interface) and the entire, or at least the rear mating connector portion, needs to be replaced at great expense.

### BRIEF DESCRIPTION OF THE INVENTION

In one embodiment, a cassette is provided that includes a shell having a front and a rear. The shell has a plurality of plug cavities open at the front for receiving plugs therein. A contact subassembly is received within the shell. The contact subassembly has a circuit board with front and rear sides, and the contact subassembly has a plurality of contacts electrically connected to the circuit board and extending from the front side. The contacts are arranged in contact sets that are configured to mate with different plugs. The contact subassembly has an electrical connector extending from the rear side, where the electrical connector is electrically connected to predetermined ones of the contacts. The cassette also includes an interface connector received within the shell that is mated with the electrical connector. The interface connector has a rear mating connector extending from the rear of the shell and is configured to mate with a mating connector.

Optionally, the interface connector may includes a circuit board with the rear mating connector mounted to the circuit board of the interface connector. The circuit board of the interface connector may be electrically connected to the circuit board of the contact subassembly by the electrical connector of the contact subassembly. The circuit board of the interface connector may have contact pads along an edge of the circuit board and the circuit board of the interface connector may be received in the electrical connector to electrically connect the contact pads to contacts of the electrical connector. Optionally, the electrical connector of the contact subassembly may be interchangeably mated with the interface connector and with a second interface connector that has a rear mating connector defining a different mating interface. The electrical connector may be electrically connected to the contacts of more than one of the contact sets. The rear mating connector may be electrically connected to the contacts of more than one of the contact sets.

In another embodiment, a cassette is provided that includes a shell defining a plurality of plug cavities for receiving plugs therein, and a contact subassembly received within the shell. The contact subassembly has a circuit board, a plurality of contacts extending from a front side of the circuit board and an electrical connector extending from a rear side of the circuit board. The contacts are configured to mate with different ones of the plugs, and the electrical connector is electrically connected to predetermined ones of the contacts. The electrical connector is configured to interchangeably mate with different types of interface connectors. Optionally, the cassette may include a first interface connector having a rear mating connector of a first type, and a second interface connector having a rear mating connector of a second type different from the first type.

In a further embodiment, a cassette is provided that includes a shelf defining a plurality of plug cavities for receiving plugs therein, and a contact subassembly received within the shell. The contact subassembly has a circuit board, a plurality of contacts extending from a front side of the circuit board and an electrical connector extending from a rear side of the circuit board. The contacts are configured to mate with corresponding plugs, and the electrical connector is electrically connected to corresponding contacts. The cassette also includes an interface connector received within the shell. The interface connector has a circuit board with contact pads arranged along an edge of the circuit board, and the circuit board is received within the electrical connector of the contact subassembly. The interface connector has a rear mating connector extending from the circuit board of the interface connector.

In yet another embodiment, a cassette is provided that includes a shell having a front and a rear, where the shell defines a plurality of plug cavities for receiving plugs therein. The plug cavities define front plug cavities being arranged at the front and the plug cavities define rear plug cavities being arranged at the rear are arranged at the front and at the rear. The cassette also includes a front contact subassembly received within the shell, where the front contact subassembly has a plurality of contacts being arranged within the front plug cavities and being configured to mate with different ones of the plugs at the front of the shell. The cassette also includes a rear contact subassembly received in the shell, where the rear contact subassembly has a plurality of contacts being arranged in the rear plug cavities and being configured to mate with different ones of the plugs at the front of the shell. At least one circuit board is arranged between the contacts of the front and the rear contact subassemblies. The contacts of the front contact subassembly are electrically connected to corresponding contacts of the rear contact subassembly via the at least one circuit board.

### BRIEF DESCRIPTION OF THE DRAWINGS

FIG. 1 is a front perspective view of a portion of a cable interconnect system incorporating a plurality of cassettes mounted to the panel with a modular plug connected thereto.

FIG. 2 is an exploded view of the panel and the cassettes illustrated in FIG. 1.

FIG. 3 is a front perspective view of an alternative panel for the cable interconnect system with cassettes mounted thereto.

FIG. 4 is a rear perspective view of a cassette shown in FIG. 1.

FIG. 5 is a rear exploded view of the cassette shown in FIG. 4.

FIG. 6 illustrates a contact subassembly of the cassette shown in FIG. 4.

FIG. 7 is a front perspective view of a housing of the cassette shown in FIG. 4.

FIG. 8 is a rear perspective view of the housing shown in FIG. 7.

FIG. 9 is a rear perspective view of the cassette shown in FIG. 4 during assembly.

FIG. 10 is a side perspective, partial cutaway view of the cassette shown in FIG. 4.

FIG. 11 is a cross-sectional view of the cassette shown in FIG. 4.

FIG. 12 is an exploded rear perspective view of the cassette having an alternative interface connector and an alternative cover.

FIG. 13 is a partial cutaway view of the contact subassembly and an alternative interface connector 240 mated there with.

FIG. 14 illustrates an alternative contact subassembly and corresponding interface connector for use with the cassette shown in FIG. 1.

FIG. 15 illustrates yet another alternative contact subassembly and corresponding interface connector for use with the cassette shown in FIG. 1.

### DETAILED DESCRIPTION OF THE INVENTION

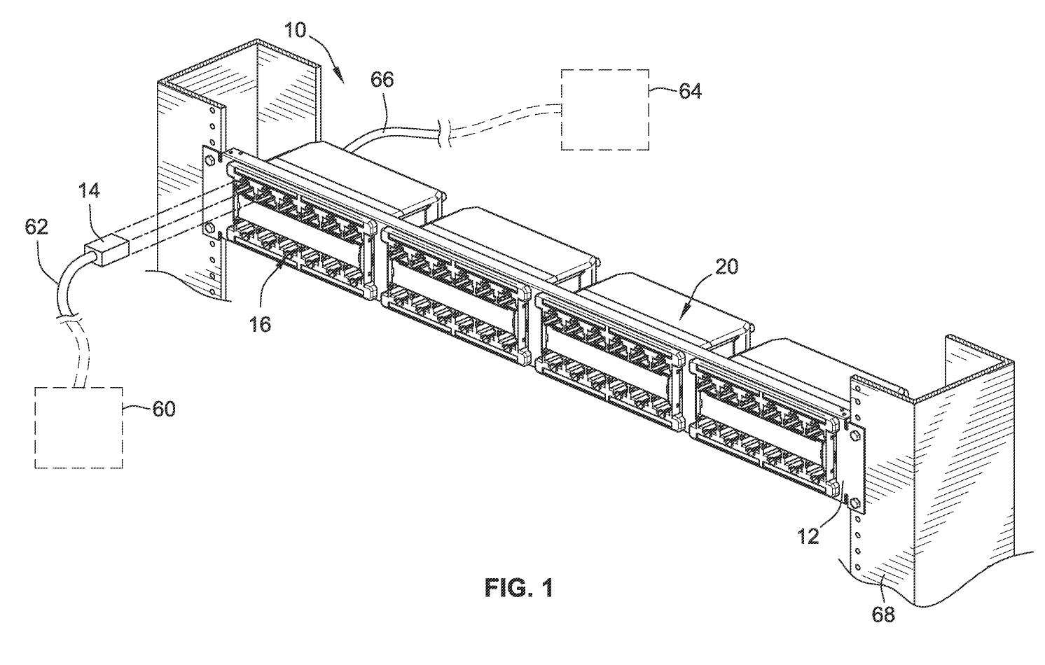

FIG. 1 is a front perspective view of a portion of a cable interconnect system 10 illustrating a panel 12 and a plurality of cassettes 20 mounted to the panel 12 and a modular plug 14 connected thereto. The cassette 20 comprises an array of receptacles 16 for accepting or receiving the modular plug 14.

The cable interconnect system 10 is utilized to interconnect various equipment, components and/or devices to one another. FIG. 1 schematically illustrates a first device 60 connected to the cassette 20 via a cable 62. The modular plug 14 is attached to the end of the cable 62. FIG. 1 also illustrates a second device 64 connected to the cassette 20 via a cable 66. The cassette 20 interconnects the first and second devices 60, 64. In an exemplary embodiment, the first device 60 may be a computer located remote from the cassette 20. The second device 64 may be a network switch. The second device 64 may be located in the vicinity of the cassette 20, such as in the same equipment room, or alternatively, may be located remote from the cassette 20. The cable interconnect system 10 may include a support structure 68, a portion of which is illustrated in FIG. 1, for supporting the panel 12 and the cassettes 20. For example, the support structure 68 may be an equipment rack of a network system. The panel 12 may be a patch panel that is mounted to the equipment rack. In alternative embodiments, rather than a patch panel, the panel 12 may be another type of network component used with a network system that supports cassettes 20 and/or other connector assemblies, such as interface modules, stacked jacks, or other individual modular jacks. For example, the panel 12 may be a wall or other structural element of a component. It is noted that the cable interconnect system 10 illustrated in FIG. 1 is merely illustrative of an exemplary system/component for interconnecting communication cables using modular jacks and modular plugs or other types of connectors. Optionally, the second device 64 may be mounted to the support structure 68.

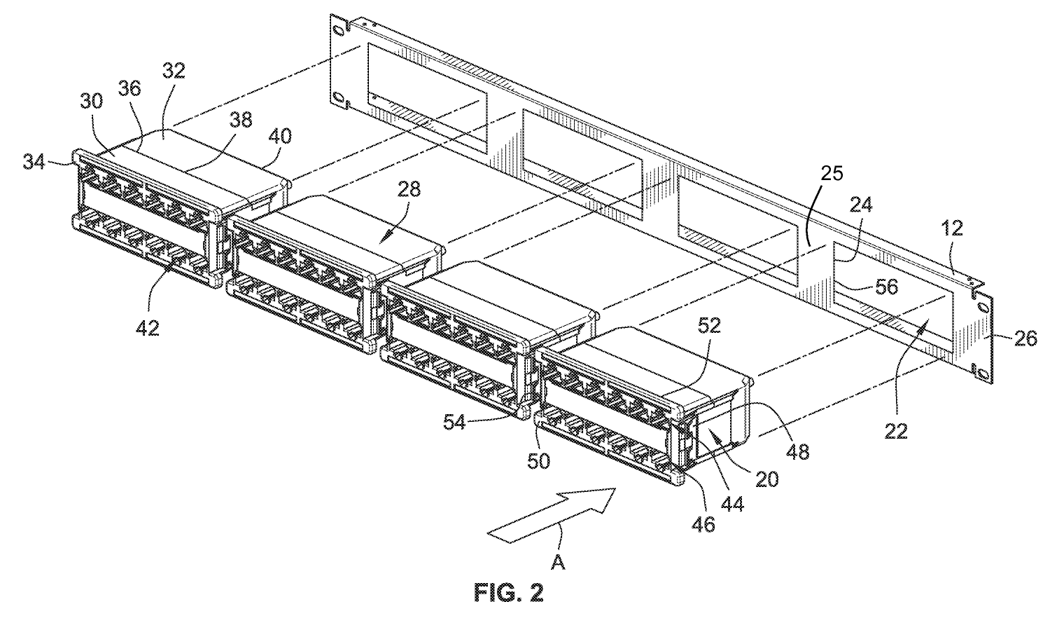

FIG. 2 is an exploded view of the panel 12 and the cassettes 20. The cassettes 20 are mounted within openings 22 of the panel 12. The openings 20 are defined by a perimeter wall 24. In an exemplary embodiment, the panel 12 includes a plurality of openings 22 for receiving a plurality of cassettes 20. The panel 12 includes a planar front surface 25, and the cassettes 20 are mounted against the front surface 25. The panel 12 includes mounting tabs 26 on the sides thereof for mounting to the support structure 68 (shown in FIG. 1). For example, the mounting tabs 26 may be provided at the sides of the panel 12 for mounting to a standard equipment rack or other cabinet system. Optionally, the panel 12 and mounting tabs 26 fit into 1 U height requirements.

The cassette 20 includes a shell 28 defining an outer perimeter of the cassette 20. In an exemplary embodiment, the shell 28 is a two piece design having a housing 30 and a cover 32 that may be coupled to the housing 30. The housing 30 and the cover 32 may have similar dimensions (e.g. height and width) to nest with one another to define a smooth outer surface. The housing 30 and the cover 32 may also have similar lengths, such that the housing 30 and the cover 32 mate approximately in the middle of the shell 28. Alternatively, the housing 30 may define substantially all of the shell 28 and the cover 32 may be substantially flat and be coupled to an end of the housing 30. Other alternative embodiments may not include the cover 32.

The housing 30 includes a front 34 and a rear 36. The cover 32 includes a front 38 and a rear 40. The front 34 of the housing 30 defines a front of the cassette 20 and the rear 40 of the cover 32 defines a rear of the cassette 20. In an exemplary embodiment, the cover 32 is coupled to the housing 30 such that the rear 36 of the housing 30 abuts against the front 38 of the cover 32.

The housing 30 includes a plurality of plug cavities 42 open at the front 34 of the housing 30 for receiving the modular plugs 14 (shown in FIG. 1). The plug cavities 42 define a portion of the receptacles 16. In an exemplary embodiment, the plug cavities 42 are arranged in a stacked configuration in a first row 44 and a second row 46 of plug cavities 42. A plurality of plug cavities 42 are arranged in each of the first and second rows 44, 46. In the illustrated embodiment, six plug cavities 42 are arranged in each of the first and second rows 44, 46, thus providing a total of twelve plug cavities 42 in each cassette 20. Four cassettes 20 are provided that are mounted to the panel 12, thus providing a total of forty-eight plug cavities 42. Such an arrangement provides forty-eight plug cavities 42 that receive forty-eight modular plugs 14 within the panel 12 that fits within 1 U height requirement. It is realized that the cassettes 20 may have more or less than twelve plug cavities 42 arranged in more or less than two rows of plug cavities 42. It is also realized that more or less than four cassettes 20 may be provided for mounting to the panel 12.

The cassette 20 includes latch members 48 on one or more sides of the cassette 20 for securing the cassette 20 to the panel 12. The latch members 48 may be held close to the sides of the cassette 20 to maintain a smaller form factor. Alternative mounting means may be utilized in alternative embodiments. The latch members 48 may be separately provided from the housing 30 and/or the cover 32. Alternatively, the latch members 48 may be integrally formed with the housing 30 and/or the cover 32.

During assembly, the cassettes 20 are loaded into the openings 22 of the panel 12 from the front of the panel 12, such as in the loading direction illustrated in FIG. 2 by an arrow A. The outer perimeter of the cassette 20 may be substantially similar to the size and shape of the perimeter walls 24 defining the openings 22 such that the cassette 20 fits snugly within the openings 22. The latch members 48 are used to secure the cassettes 20 to the panel 12. In an exemplary embodiment, the cassettes 20 include a front flange 50 at the front 34 of the housing 30. The front flanges 50 have a rear engagement surface 52 that engages the front surface 25 of the panel 12 and the cassette 20 is loaded into the openings 22. The latch members 48 include a panel engagement surface 54 that is forward facing such that, when the cassette 20 is loaded into the opening 22, the panel engagement surface 54 engages a rear surface 56 of the panel 12. The panel 12 is captured between the rear engagement surface 52 of the front flanges 50 and the panel engagement surfaces 54 of the latch members 48.

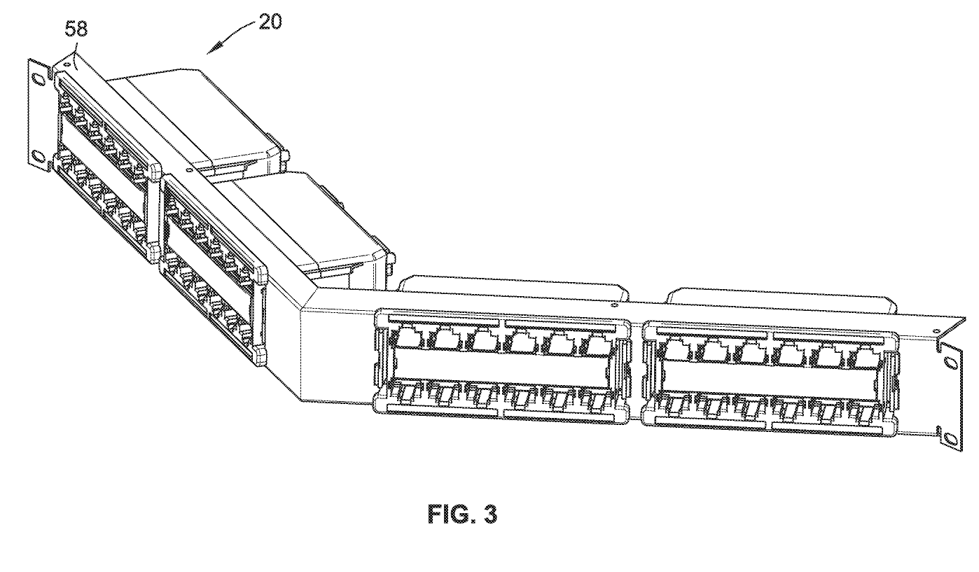

FIG. 3 is a front perspective view of an alternative panel 58 for the cable interconnect system 10 with cassettes 20 mounted thereto. The panel 58 has a V-configuration such that the cassettes 20 are angled in different directions. Other panel configurations are possible in alternative embodiments. The cassettes 20 may be mounted to the panel 58 in a similar manner as the cassettes 20 are mounted to the panel 12 (shown in FIG. 1). The panel 58 may fit within 1 U height requirements.

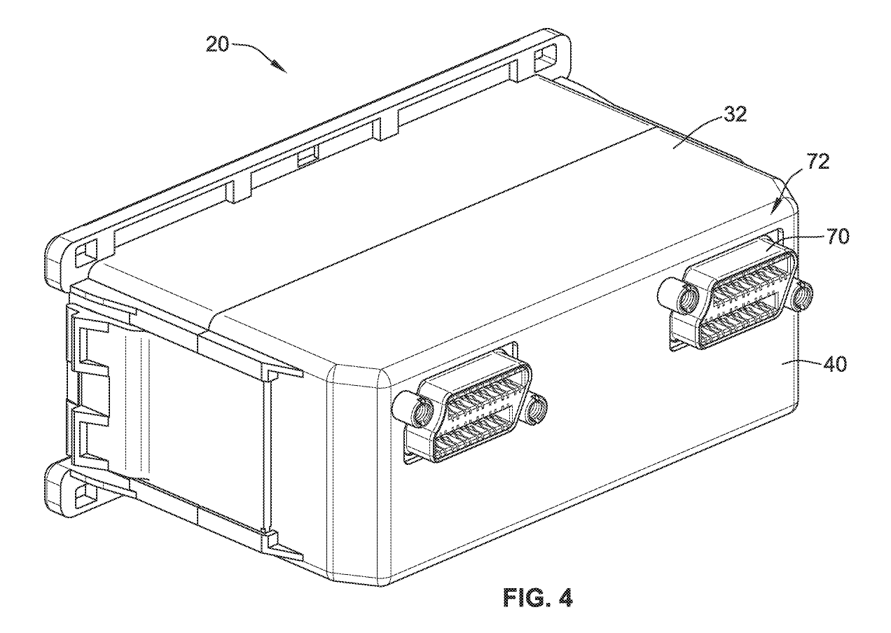

FIG. 4 is a rear perspective view of one of the cassettes 20 illustrating a plurality of rear mating connectors 70. The rear mating connectors 70 are configured to mate with cable assemblies having a mating cable connector where the cable assemblies are routed to another device or component of the cable interconnect system 10 (shown in FIG. 1). For example, the cable connectors may be provided at ends of cables that are routed behind the panel 12 to a network switch or other network component. Optionally, a portion of the rear mating connectors 70 may extend through an opening 72 in the rear 40 of the cover 32. In the illustrated embodiment, the rear mating connectors 70 are represented by board mounted MRJ-21 connectors, however, it is realized that other types of connectors may be used rather than MRJ-21 type of connectors. For example, in alternative embodiments, the rear mating connectors 70 may be another type of copper-based modular connectors, fiber optic connectors or other types of connectors, such as eSATA connectors, HDMI connectors, USB connectors, FireWire connectors, and the like.

As will be described in further detail below, the rear mating connectors 70 are high density connectors, that is, each rear mating connector 70 is electrically connected to more than one of the receptacles 16 (shown in FIG. 1) to allow communication between multiple modular plugs 14 (shown in FIG. 1) and the cable connector that mates with the rear mating connector 70. The rear mating connectors 70 are electrically connected to more than one receptacles 16 to reduce the number of cable assemblies that interface with the rear of the cassette 20. It is realized that more or less than two rear mating connectors 70 may be provided in alternative embodiments.

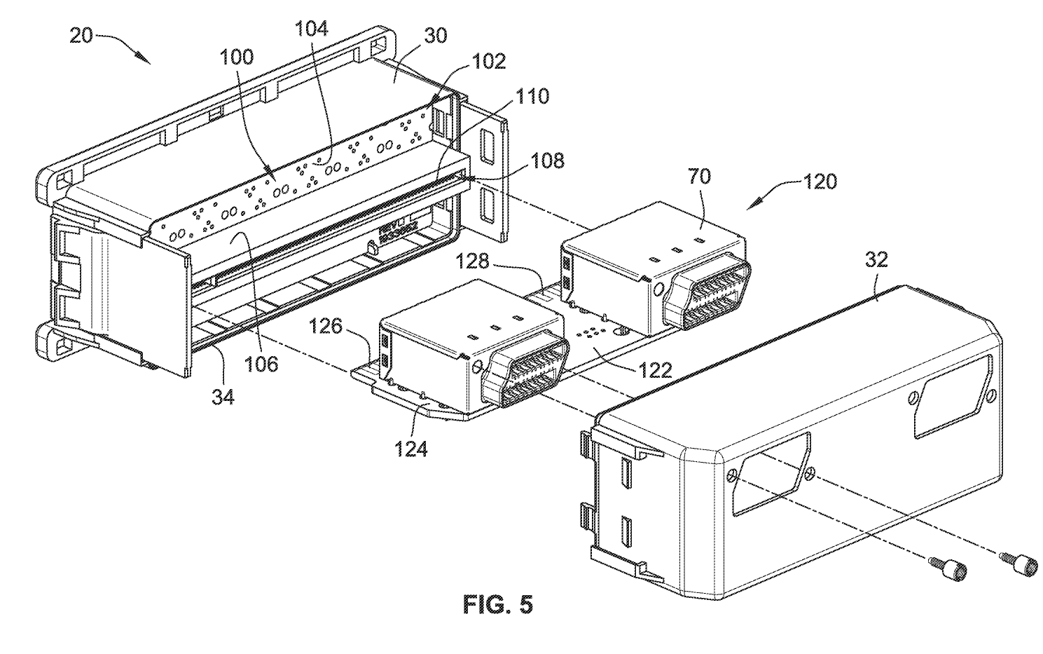

FIG. 5 is a rear exploded view of the cassette 20 illustrating the cover 32 removed from the housing 30. The cassette 20 includes a contact subassembly 100 loaded into the housing 30. In an exemplary embodiment, the housing 30 includes a rear chamber 102 at the rear 36 thereof. The contact subassembly 100 is at least partially received in the rear chamber 102. The contact subassembly 100 includes a circuit board 104 and one or more electrical connectors 106 mounted to the circuit board 104. In an exemplary embodiment, the electrical connector 106 is a card edge connector. The electrical connector 106 includes at least one opening 108 and one or more contacts 110 within the opening 108. In the illustrated embodiment, the opening 108 is an elongated slot and a plurality of contacts 110 are arranged within the slot. The contacts 110 may be provided on one or both sides of the slot. The contacts 110 may be electrically connected to the circuit board 104.

The cassette 20 includes an interface connector assembly 120 that includes the rear mating connectors 70. The interface connector assembly 120 is configured to be mated with the electrical connector 106. In an exemplary embodiment, the interface connector assembly 120 includes a circuit board 122. The rear mating connectors 70 are mounted to a side surface 124 of the circuit board 122. In an exemplary embodiment, the circuit board 122 includes a plurality of edge contacts 126 along an edge 128 of the circuit board 122. The edge contacts 126 may be mated with the contacts 110 of the contact subassembly 100 by plugging the edge 128 of the circuit board 122 into the opening 108 of the electrical connector 106. The edge contacts 126 are electrically connected to the rear mating connectors 70 via the circuit board 122. For example, traces may be provided on or in the circuit board 122 that interconnect the edge contacts 126 with the rear mating connectors 70. The edge contacts 126 may be provided on one or more sides of the circuit board 122. The edge contacts 126 may be contact pads formed on the circuit board 122. Alternatively, the edge contacts 126 may extend from at least one of the surfaces and/or the edge 128 of the circuit board 122. In alternative embodiment, rather than using edge contacts 126, the interface connector assembly 120 may include an electrical connector at, or proximate to, the edge 128 for mating with the electrical connector 106 of the contact subassembly 100.

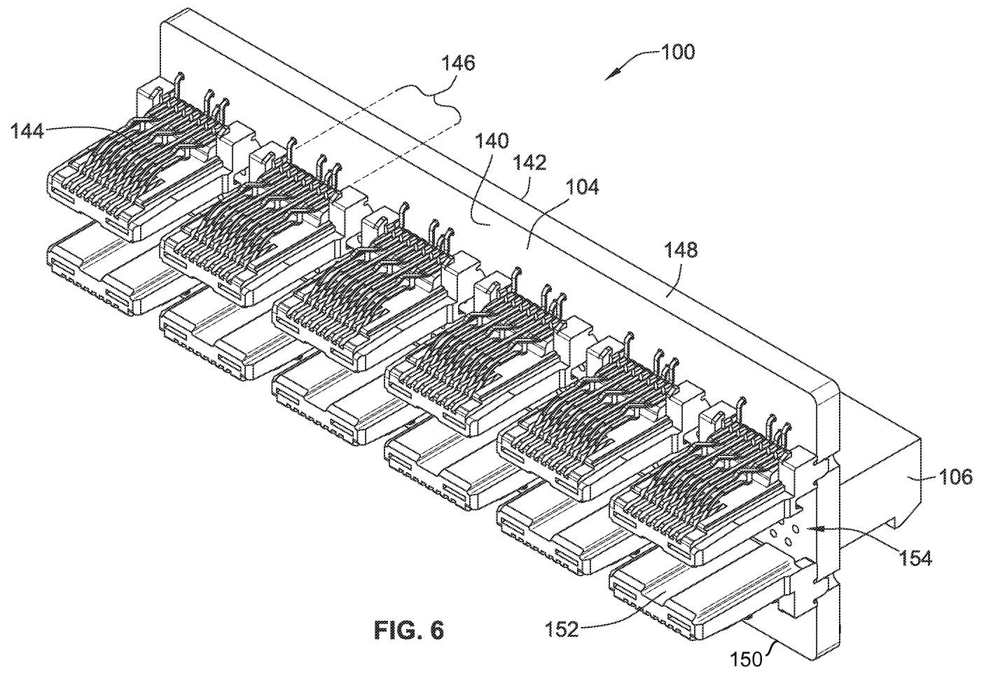

FIG. 6 illustrates the contact subassembly 100 of the cassette 20 (shown in FIG. 4). The circuit board 104 of the contact subassembly 100 includes a front side 140 and a rear side 142. The electrical connector 106 is mounted to the rear side 142. A plurality of contacts 144 extend from the front side 140 of the circuit board 104. The contacts 144 are electrically connected to the circuit board 104 and are electrically connected to the electrical connector 106 via the circuit board 104.

The contacts 144 are arranged in contact sets 146 with each contact set 146 defining a portion of a different receptacle 16 (shown in FIG. 1). For example, in the illustrated embodiment, eight contacts 144 are configured as a contact array defining each of the contact sets 146. The contacts 144 may constitute a contact array that is configured to mate with plug contacts of an RJ-45 modular plug. The contacts 144 may have a different configuration for mating with a different type of plug in alternative embodiments. More or less than eight contacts 144 may be provided in alternative embodiments. In the illustrated embodiment, six contact sets 146 are arranged in each of two rows in a stacked configuration, thus providing a total of twelve contact sets 146 for the contact subassembly 100. Optionally, the contact sets 146 may be substantially aligned with one another within each of the rows and may be aligned above or below another contact set 146. For example, an upper contact set 146 maybe positioned relatively closer to a top 148 of the circuit board 104 as compared to a lower contact set 146 which may be positioned relatively closer to a bottom 150 of the circuit board 104.

In an exemplary embodiment, the contact subassembly 100 includes a plurality of contact supports 152 extending from the front side 140 of the circuit board 104. The contact supports 152 are positioned in close proximity to respective contact sets 146. Optionally, each contact support 152 supports the contacts 144 of a different contact set 146. In the illustrated embodiment, two rows of contact supports 152 are provided. A gap 154 separates the contact supports 152. Optionally, the gap 154 may be substantially centered between the top 148 and the bottom 150 of the circuit board 104.

During assembly, the contact subassembly 100 is loaded into the housing 30 (shown in FIG. 2) such that the contact sets 146 and the contact supports 152 are loaded into corresponding plug cavities 42 (shown in FIG. 2). In an exemplary embodiment, a portion of the housing 30 extends between adjacent contact supports 152 within a row, and a portion of the housing 30 extends into the gap 154 between the contact supports 152.

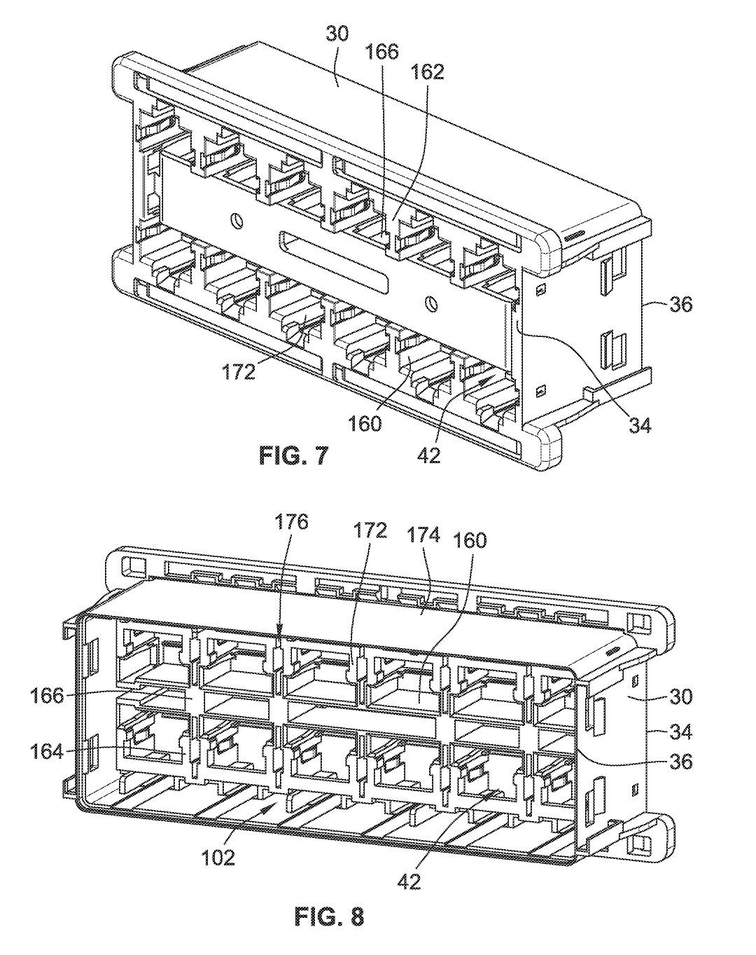

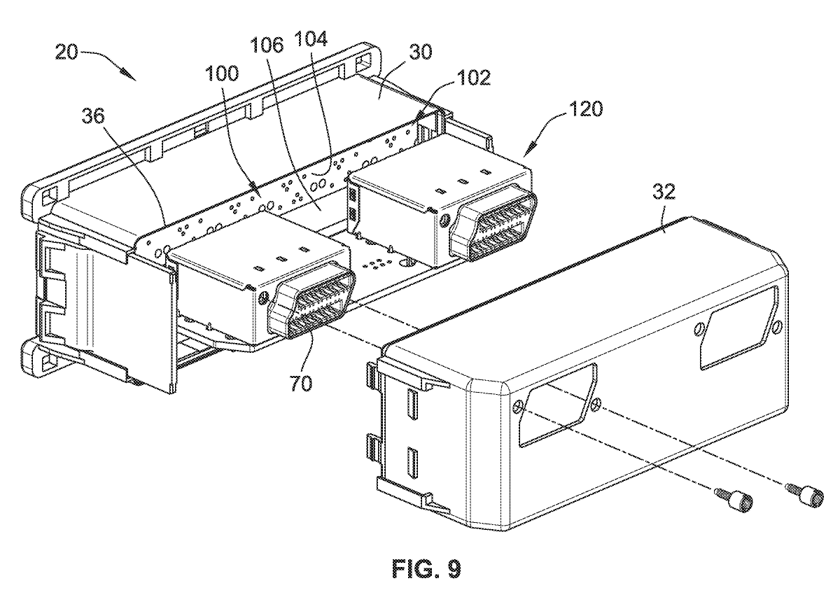

FIGS. 7 and 8 are front and rear perspective views, respectively, of the housing 30 of the cassette 20 (shown in FIG. 1). The housing 30 includes a plurality of interior walls 160 that extend between adjacent plug cavities 42. The walls 160 may extend at least partially between the front 34 and the rear 36 of the housing 30. The walls 160 have a front surface 162 (shown in FIG. 7) and a rear surface 164 (shown in FIG. 8). Optionally, the front surface 162 may be positioned at, or proximate to, the front 34 of the housing 30. The rear surface 164 may be positioned remote with respect to, and/or recessed from, the rear 36 of the housing 30. The housing 30 includes a tongue 166 represented by one of the walls 160 extending between the first and second rows 44, 46 of plug cavities 42. Optionally, the interior walls 160 may be formed integral with the housing 30.

In an exemplary embodiment, the housing 30 includes a rear chamber 102 (shown in FIG. 8) at the rear 36 of the housing 30. The rear chamber 102 is open to each of the plug cavities 42. Optionally, the rear chamber 102 extends from the rear 36 of the housing 30 to the rear surfaces 164 of the walls 160. The rear chamber 102 is open at the rear 36 of the housing 30. In the illustrated embodiment, the rear chamber 102 is generally box-shaped, however the rear chamber 102 may have any other shape depending on the particular application and/or the size and shape of the components filling the rear chamber 102.

In an exemplary embodiment, the plug cavities 42 are separated from adjacent plug cavities 42 by shield elements 172. The shield elements 172 may be defined by the interior walls 160 and/or exterior walls 174 of the housing 30. For example the housing 30 may be fabricated from a metal material with the interior walls 160 and/or the exterior walls 174 also fabricated from the metal material. In an exemplary embodiment, the housing 30 is diecast using a metal or metal alloy, such as aluminum or an aluminum alloy. With the entire housing 30 being metal, the housing 30, including the portion of the housing 30 between the plug cavities 42 (e.g. the interior walls 160) and the portion of the housing 30 covering the plug cavities 42 (e.g. the exterior walls 174), operates to provide shielding around the plug cavities 42. In such an embodiment, the housing 30 itself defines the shield elements(s) 172. The plug cavities 42 maybe completely enclosed (e.g. circumferentially surrounded) by the shield elements 172.

With each contact set 146 (shown in FIG. 6) arranged within a different plug cavity 42, the shield elements 172 provide shielding between adjacent contact sets 146. The shield elements 172 thus provide isolation between the adjacent contact sets 146 to enhance the electrical performance of the contact sets 146 received in each plug cavity 42. Having shield elements 172 between adjacent plug cavities 42 provides better shield effectiveness for the cable interconnect system 10 (shown in FIG. 1), which may enhance electrical performance in systems that utilize components that do not provide shielding between adjacent plug cavities 42. For example, having shield elements 172 between adjacent plug cavities 42 within a given row 44, 46 enhances electrical performance of the contact sets 146. Additionally, having shield elements 172 between the rows 44, 46 of plug cavities 42 may enhance the electrical performance of the contact sets 146. The shield elements 172 may reduce alien crosstalk between adjacent contact sets 146 in a particular cassette and/or reduce alien crosstalk with contact sets 146 of different cassettes 20 or other electrical components in the vicinity of the cassette 20. The shield elements may also enhance electrical performance of the cassette 20 in other ways, such as by providing EMI shielding or by affecting coupling attenuation, and the like.

In an alternative embodiment, rather than the housing 30 being fabricated from a metal material, the housing 30 may be fabricated, at least in part, from a dielectric material. Optionally, the housing 30 may be selectively metallized, with the metallized portions defining the shield elements 172. For example, at least a portion of the housing 30 between the plug cavities 42 may be metallized to define the shield elements 172 between the plug cavities 42. Portions of the interior walls 160 and/or the exterior walls 174 may be metallized. The metallized surfaces define the shield elements 172. As such, the shield elements 172 are provided on the interior walls 160 and/or the exterior walls 174. Alternatively, the shield elements 172 may be provided on the interior walls 160 and/or the exterior walls 174 in a different manner, such as by plating or by coupling separate shield elements 172 to the interior walls 160 and/or the exterior walls 174. The shield elements 172 may be arranged along the surfaces defining the plug cavities 42 such that at least some of the shield elements 172 engage the modular plugs 14 when the modular plugs 14 are loaded into the plug cavities 42. In other alternative embodiments, the walls 160 and/or 174 may be formed, at least in part, by metal filler materials provided within or on the walls 160 and/or 174 or metal fibers provided within or on the walls 160 and/or 174.

In another alternative embodiment, rather than, or in addition to, providing the shield elements 172 on the walls of the housing 30, the shield elements 172 may be provided within the walls of the housing 30. For example, the interior walls 160 and/or the exterior walls 174 may include openings 176 that are open at the rear 36 and/or the front 34 such that the shield elements 172 may be loaded into the openings 176. The shield elements 172 may be separate metal components, such as plates, that are loaded into the openings 176. The openings 176, and thus the shield elements 172, are positioned between the plug cavities 42 to provide shielding between adjacent contact sets 146.

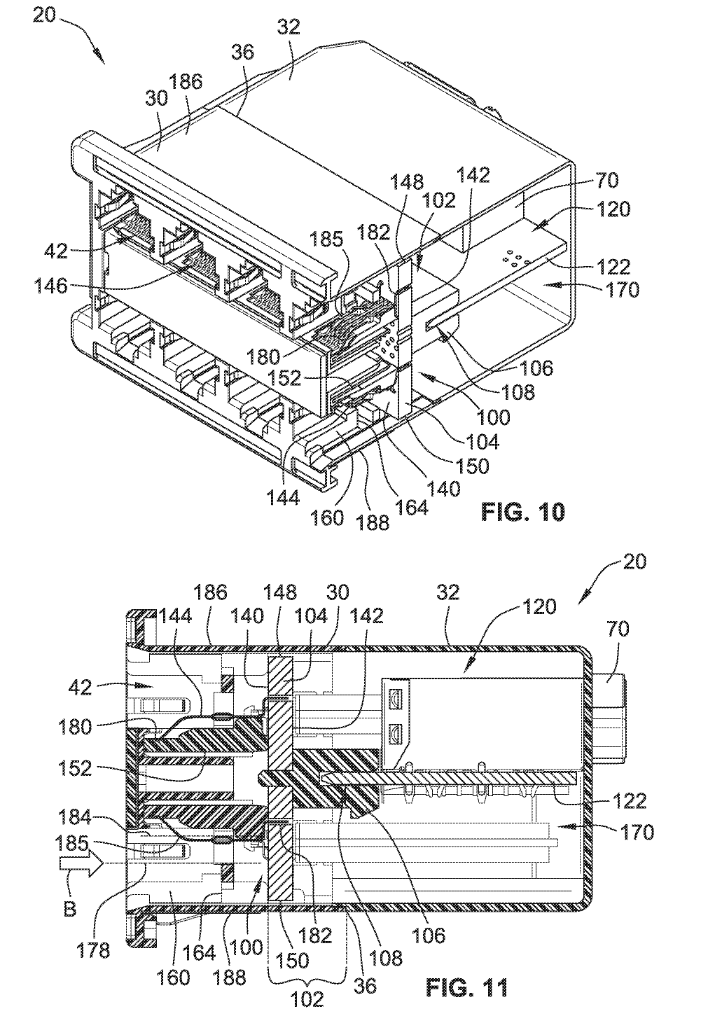

FIG. 9 is a rear perspective, partially assembled, view of the cassette 20. During assembly, the contact subassembly 100 is loaded into the rear chamber 102 of the housing 30 through the rear 36. Optionally, the circuit board 104 may substantially fill the rear chamber 102. The contact subassembly 100 is loaded into the rear chamber 102 such that the electrical connector 106 faces the rear 36 of the housing 30. The electrical connector 106 may be at least partially received in the rear chamber 102 and at least a portion of the electrical connector 106 may extend from the rear chamber 102 beyond the rear 36.

During assembly, the interface connector assembly 120 is mated with the electrical connector 106. Optionally, the interface connector assembly 120 may be mated with the electrical connector 106 after the contact subassembly 100 is loaded into the housing 30. Alternatively, both the contact subassembly 100 and the interface connector assembly 120 may be loaded into the housing 30 as a unit. Optionally, some or all of the interface connector assembly 120 may be positioned rearward of the housing 30.

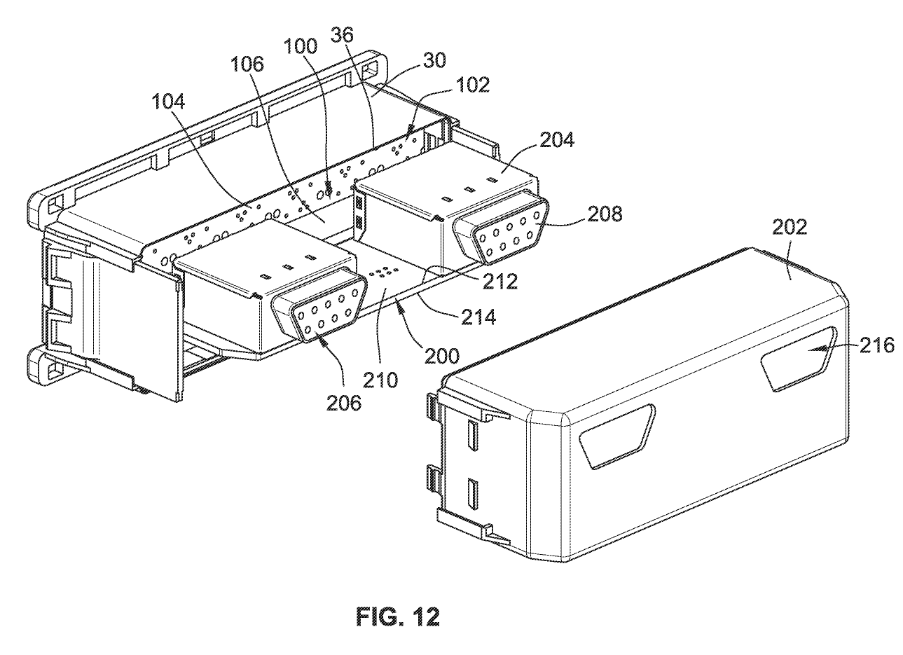

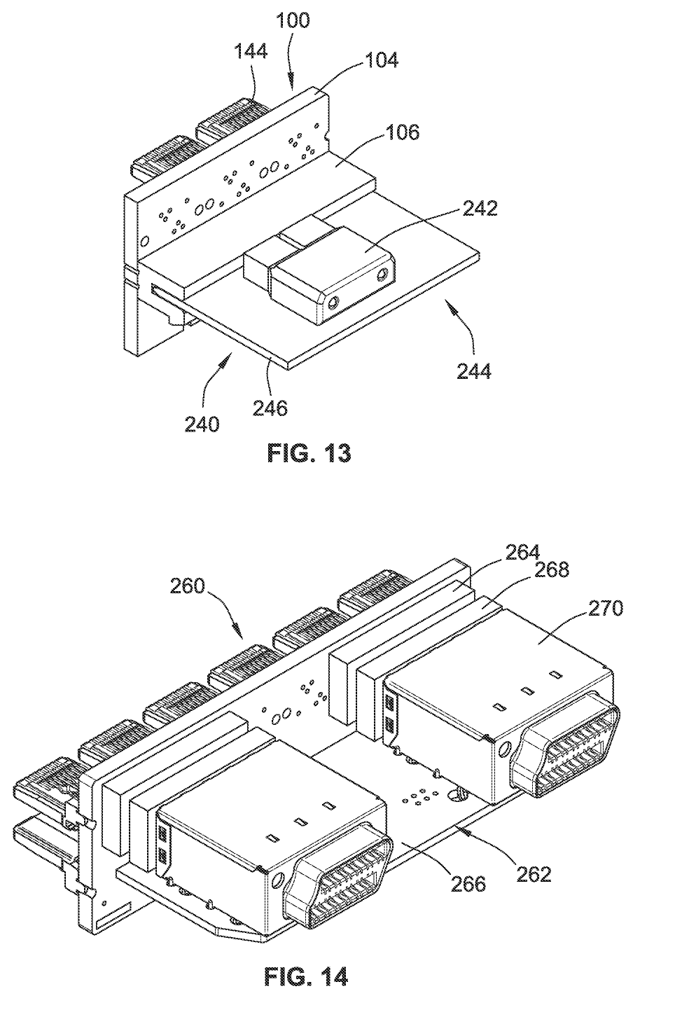

The cover 32 is coupled to the housing 30 after the contact subassembly 100 and the interface connector assembly 120 are positioned with respect to the housing 30. The cover 32 is coupled to the housing 30 such that the cover 32 surrounds the interface connector assembly 120 and/or the contact subassembly 100. In an exemplary embodiment, when the cover 32 and the housing 30 are coupled together, the cover 32 and the housing 30 cooperate to define an inner chamber 170 (shown in FIGS. 10 and 11). The rear chamber 102 of the housing 30 defines part of the inner chamber 170, with the hollow interior of the cover 32 defining another part of the inner chamber 170. The interface connector assembly 120 and the contact subassembly 100 are received in the inner chamber 170 and protected from the external environment by the cover 32 and the housing 30. Optionally, the cover 32 and the housing 30 may provide shielding for the components housed within the inner chamber 170. The rear mating connectors 70 may extend through the cover 32 when the cover 32 is coupled to the housing 30. As such, the rear mating connectors 70 may extend at least partially out of the inner chamber 170.

FIG. 10 is a side perspective, partial cutaway view of the cassette 20 and FIG. 11 is a cross-sectional view of the cassette 20. FIGS. 10 and 11 illustrate the contact subassembly 100 and the interface connector assembly 120 positioned within the inner chamber 170, with the cover 32 coupled to the housing 30. The contact subassembly 100 is loaded into the rear chamber 102 such that the front side 140 of the circuit board 104 generally faces the rear surfaces 164 of the walls 160. Optionally, the front side 140 may abut against a structure of the housing 30, such as the rear surfaces 164 of the walls 160, or alternatively, a rib or tab that extends from the housing 30 for locating the contact subassembly 100 within the housing 30. When the contact subassembly 100 is loaded into the rear chamber 102, the contacts 144 and the contact supports 152 are loaded into corresponding plug cavities 42.

When assembled, the plug cavities 42 and the contact sets 146 cooperate to define the receptacles 16 for mating with the modular plugs 14 (shown in FIG. 1). The walls 160 of the housing 30 define the walls of the receptacles 16 and the modular plugs 14 engage the walls 160 when the modular plugs 14 are loaded into the plug cavities 42. The contacts 144 are presented within the plug cavities 42 for mating with plug contacts of the modular plugs 14. In an exemplary embodiment, when the contact subassembly 100 is loaded into the housing 30, the contact supports 152 are exposed within the plug cavities 42 and define one side of the box-like cavities that define the plug cavities 42.

Each of the contacts 144 extend between a tip 180 and a base 182 generally along a contact plane 184 (shown in FIG. 11). A portion of the contact 144 between the tip 180 and the base 182 defines a mating interface 185. The contact plane 184 extends parallel to the modular plug loading direction, shown in FIG. 11 by the arrow B, which extends generally along a plug axis 178. Optionally, the tip 180 may be angled out of the contact plane 184 such that the tips 180 do not interfere with the modular plug 14 during loading of modular plug 14 into the plug cavity 42. The tips 180 may be angled towards and/or engage the contact supports 152. Optionally, the bases 182 may be angled out of the contact plane 184 such that the bases 182 may be terminated to the circuit board 104 at a predetermined location. The contacts 144, including the tips 180 and the bases 182, may be oriented with respect to One another to control electrical properties therebetween, such as crosstalk. In an exemplary embodiment, each of the tips 180 within the contact set 146 are generally aligned one another. The bases 182 of adjacent contacts 144 may extend either in the same direction or in a different direction as one another. For example, at least some of the bases 182 extend towards the top 148 of the circuit board 104, whereas some of the bases 182 extend towards the bottom of 150 of the circuit board 104.

In an exemplary embodiment, the circuit board 104 is generally perpendicular to the contact plane 184 and the plug axis 178. The top 148 of the circuit board 104 is positioned near a top side 186 of the housing 30, whereas the bottom 150 of the circuit board 104 is positioned near a bottom side 188 of the housing 30. The circuit board 104 is positioned generally behind the contacts 144, such as between the contacts 144 and the rear 36 of the housing 30. The circuit board 104 substantially covers the rear of each of the plug cavities 42 when the connector subassembly 100 is loaded into the rear chamber 102. In an exemplary embodiment, the circuit board 104 is positioned essentially equidistant from the mating interface 185 of each of the contacts 144. As such, the contact length between the mating interface 185 and the circuit board 104 is substantially similar for each of the contacts 144. Each of the contacts 144 may thus exhibit similar electrical characteristics. Optionally, the contact length may be selected such that the distance between a mating interface 185 and the circuit board 104 is reasonably short. Additionally, the contact lengths of the contacts 144 in the upper row 44 (shown in FIG. 2) of plug cavities 42 are substantially similar to the contact lengths of the contacts 144 in the lower row 46 (shown in FIG. 2) of plug cavities 42.

The electrical Connector 106 is provided on the rear side 142 of the circuit board 104. The electrical connector 106 is electrically connected to the contacts 144 of one or more of the contacts sets 146. The interface connector assembly 120 is mated with the electrical connector 106. For example, the circuit board 122 of the interface connector assembly 120 is loaded into the opening 108 of the electrical connector 106. The rear mating connectors 70, which are mounted to the circuit board 122, are electrically connected to predetermined contacts 144 of the contacts sets 146 via the circuit board 122, the electrical connector 106 and the circuit hoard 104. Other configurations are possible to interconnect the rear mating connectors 70 with the contacts 44 of the receptacles 16.

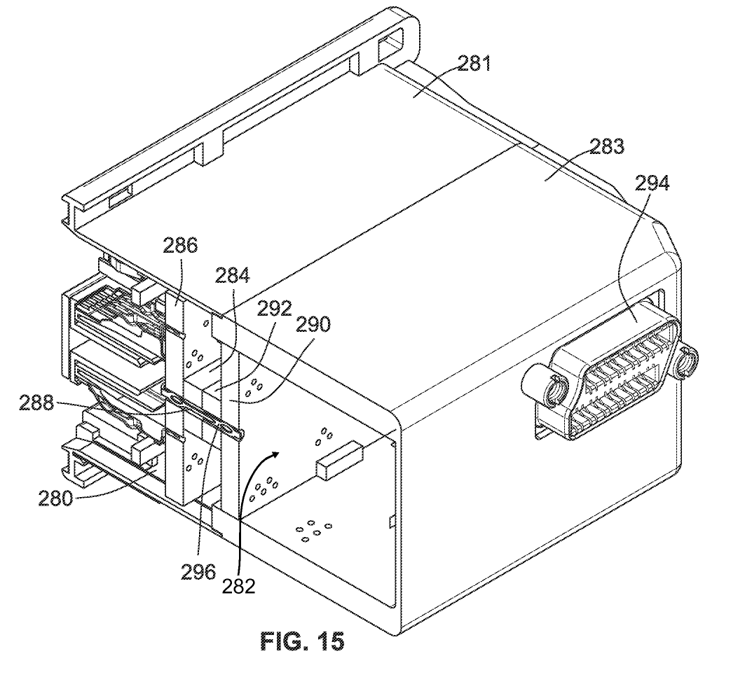

FIG. 12 is an exploded rear perspective view of the cassette 20 having an alternative interface connector 200 and an alternative cover 202. The cassette 20 includes the housing 30 with the rear chamber 102 and the rear 36 of the housing 30. The contact subassembly 100 is received within the rear chamber 102. The electrical connector 106 extends rearward from the circuit board 104. The interface connector 200 is mated with the electrical connector 106 in a similar manner as the interface connector assembly 120 (shown in FIG. 5).

In the illustrated embodiment, the interface connector 200 is similar to the interface connector assembly 120, however the interface connector 200 includes rear mating connectors 204 that are different from the rear mating connectors 70 (shown in FIG. 5). For example, the rear mating connectors 204 have a different rear mating interface 206 as compared to the rear mating connectors 70. In the illustrated embodiment, the rear mating connectors 204 represent high-density connectors, such as the HD-20 connector, commercially available from Tyco Electronics Corporation. Optionally, the rear mating connector 204 is a receptacle connector having a plurality of sockets 208 that are configured to receive pins (not shown) of a plug connector (not shown) that is mated with the rear mating connectors 204. A different number of rear mating connectors 204 may be provided in alternative embodiments.

The interface connector 200 includes a circuit board 210. The rear mating connectors 204 are mounted to a side surface 212 of the circuit board 210. The rear mating connectors 204 may be mounted differently on the circuit board 210 in alternative embodiments. For example, the rear mating connectors 204 may be mounted on the opposite side surface 214 of the circuit board 210. Rear mating connectors 204 may be provided on both sides 212, 214 of the circuit board 210 in alternative embodiments.

In an exemplary embodiment, the circuit board 210 includes a plurality of edge contacts along an edge of the circuit board 210 similar to the interface connector assembly 120. The edge contacts are electrically connected to the rear mating connectors 204 via the circuit board 210. The edge contacts may be mated with the contacts 110 (shown in FIG. 5) of the contact subassembly 100 by plugging the edge of the circuit board 210 into the opening 108 (shown in FIG. 5) of the electrical connector 106. As such, the front mating interface of the circuit board 210 is substantially similar to the front mating interface of the circuit board 122 such that the interface connector 200 and the interface connector assembly 120 may be interchangeably coupled to the electrical connector 106 depending on the particular application and the desired rear mating interface.

The cover 202 is similar to the cover 32 (shown in FIG. 2), however the cover 202 includes openings 216 that differ from the openings 72 (shown in FIG. 4). The openings 216 correspond to the rear mating connectors 204. For example, the openings 216 are shaped similar to an outer perimeter of the rear mating connectors 204. As such the rear mating connectors 204 may extend at least partially through the openings 216 for mating with the back end mating connectors. Alternatively, the openings 216 may have a complementary shape to the back end mating connectors such that at least a portion of the back end mating connectors can extend through the openings 216 for mating with the rear mating connectors 204.

In an exemplary embodiment, the back end of the cassette 20 may be changed while the cassette 20 is mounted to the panel 12 (shown in FIG. 1). For example, when upgrading or repairing the cable interconnect system 10 (shown in FIG. 1), the cover 202 may be removed from the housing 30 to expose the interface connector 200. The interface connector 200 may be removed from the electrical connector 106. A different interface connector 200, or alternatively, a different type of interface connector, such as the interface connector assembly 120, may be coupled to the electrical connector 106 and then the appropriate cover 202, 32 may be replaced and coupled to the housing 30. Such repair or upgrade may be accomplished without removing the housing 30 from the panel 12. Additionally, such repair or upgrade may be accomplished without unplugging the plugs 14 (shown in FIG. 1) from the cassette 20. As such, the repair or upgrade time may be reduced.

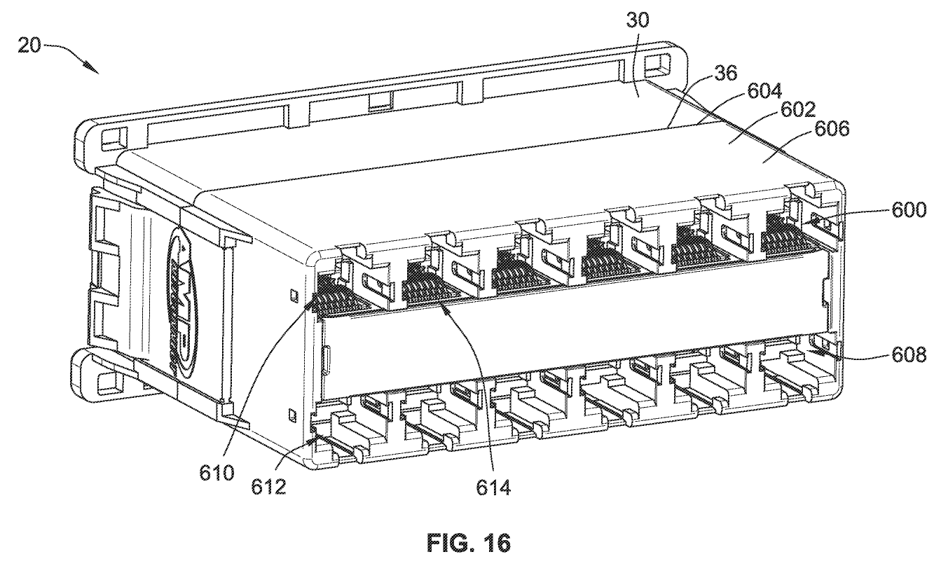

FIG. 13 is a partial cutaway view of the contact subassembly 100 and another alternative interface connector 240 mated therewith. The electrical connector 106 extends rearward from the circuit board 104. The interface connector 240 is mated with the electrical connector 106 in a similar manner as the interface connector assembly 120 (shown in FIG. 5). The interface connector 240 is similar to the interface connector assembly 120, however the interface connector 240 includes a rear mating connector 242 that is different from the rear mating connectors 70 (shown in FIG. 5). For example, the rear mating connector 242 has a different rear mating interface 244 as compared to the rear mating connectors 70. In the illustrated embodiment, the rear mating connector 242 represents a fiber-optic connector. The fiber-optic connector may be a high-density fiber-optic connector. The rear mating connector 242 is mounted to a circuit board 246. The circuit board 246 and/or the rear mating connector 242 may include electrical components, such as transceivers, for converting between fiber-optic signals and electrical signals transmitted via the contacts 144 of the contacts of assembly 100.

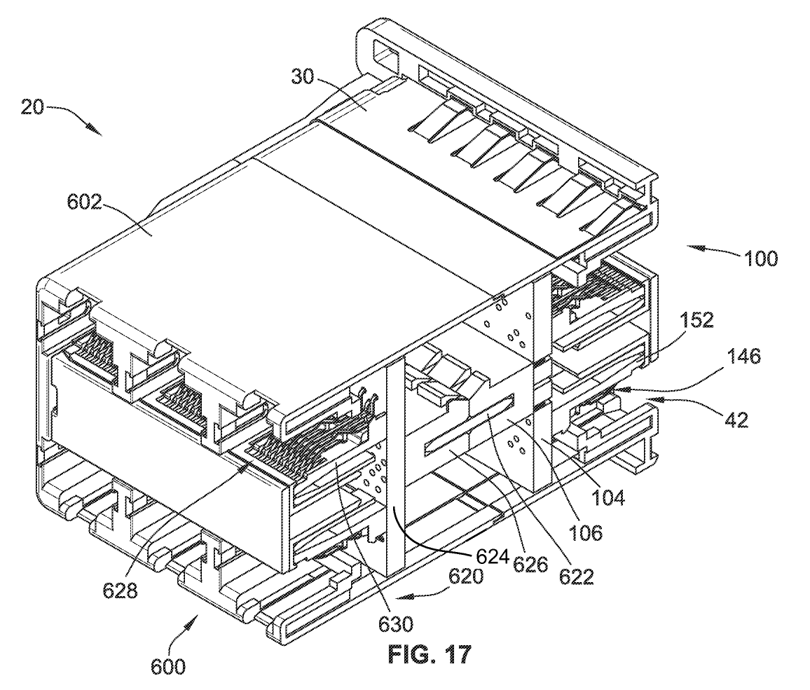

FIG. 14 illustrates an alternative contact subassembly 260 and corresponding interface connector 262 for use with the cassette 20. The contact subassembly 260 is similar to the contact subassembly 100 (see shown in FIG. 5), however the contact subassembly 260 includes electrical connectors 264 that differ from the electrical connector 106 (shown in FIG. 5). For example, the electrical connector 264 may constitute a pin and socket type of connector, as opposed to the card edge type of connector represented by the electrical connector 106. The electrical connectors 264 may be high-density electrical connectors representing one of a plug or a receptacle. Any number of electrical connectors 264 may be provided to make the electrical connection between the contact subassembly 260 and the interface connector 262. The electrical connectors 264 are electrically connected to selected ones of the contacts and/or contact sets at the front end of the contacts of assembly 260.

The interface connector 262 includes a circuit board 266, a plurality of front end electrical connectors 268 at a front end of the circuit board 266, and a plurality of rear mating connectors 270 at the rear end of the circuit board 266. The electrical connectors 268 are mated with the electrical connectors 264 of the contact subassembly 260 for electrically connecting the interface connector 262 to the contact subassembly 260. The electrical connectors 268 may be high-density electrical connectors representing one of a plug or a receptacle that complement the electrical connectors 264. As such, a pin and socket type of connection may be made between the contact subassembly 260 and the interface connector 262, as opposed to the card edge type of connection utilized by the contact subassembly 100 and interface connector assembly 120 (shown in FIG. 5). Other types of interconnections may be utilized in alternative embodiments. The rear mating connectors 270 are electrically connected to the electrical connectors 268 via the circuit board 266. In the illustrated embodiment, the rear mating connectors 270 represent RJ-21 connectors. Other types of rear mating connectors 270 may be used in alternative embodiments.

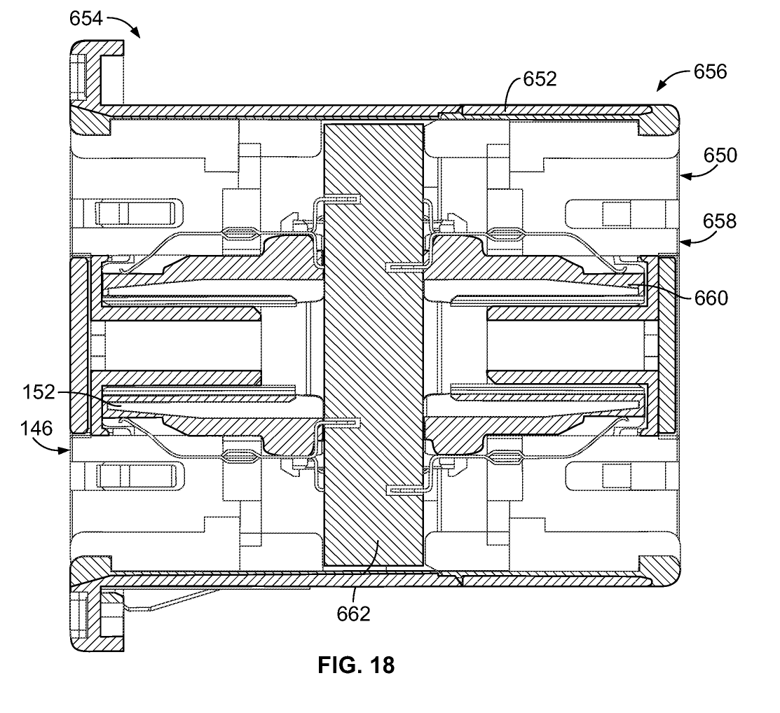

FIG. 15 illustrates yet another alternative contact subassembly 280 and corresponding interface connector 282 for use with the cassette 20. FIG. 15 illustrates a cutaway portion of the housing 281 and the cover 283. The contact subassembly 280 is similar to the contact subassembly 100 (see shown in FIG. 5), however the contact subassembly 280 includes an electrical connector(s) 284 that differs from the electrical connector 106 (shown in FIG. 5). The electrical connector 284 may be similar to the electrical connector 264 (shown in FIG. 14). The electrical connector 284 is mounted to a circuit board 286. Contacts 288 are terminated to the circuit board 286, such as by through hole mounting to the circuit board 286. In the illustrated embodiment, the contacts 288 represent pin contacts.

The interface connector 282 includes a circuit board 290, a front end electrical connector(s) 292, and a rear mating connector(s) 294. The electrical connector 292 is mated with the electrical connector 284 of the contact subassembly 280. The electrical connector 292 may be similar to the electrical connector 268 (see shown in FIG. 14). The electrical connector 292 is mounted to the circuit board 290, and contacts 296 of the electrical connector 292 are terminated to the circuit board 290, such as by through hole mounting to the circuit board 290. In the illustrated embodiment, the contacts 296 represent socket contacts. In the illustrated embodiment, the circuit board 290 is oriented generally parallel to the circuit board 286 of the contact subassembly 260. The circuit board 290 is generally positioned between the electrical connector 292 and the rear mating connector 294. The circuit board 290 is oriented generally parallel to the rear 40 of the cover 32.

FIG. 16 is a rear perspective view of the cassette 20 having an alternative interface connector 600 and an alternative cover 602. The cover 602 includes a front 604 and a rear 606. The rear 606 of the cover 602 defines a rear of the cassette 20. The cover 602 is coupled to the housing 30 of the cassette 20 such that the rear 36 of the housing 30 abuts against the front 604 of the cover 602.

The cover 602 includes a plurality of plug cavities 608 open at the rear 606 for receiving modular plugs (not shown), which may be similar to the modular plugs 14 (shown in FIG. 1) that mate with the front 34 of the housing 30. The plug cavities 608 define a jack opening for receiving the modular plugs. In an exemplary embodiment, the plug cavities 608 are arranged in a stacked configuration in a first row 610 and a second row 612 of plug cavities 608. A plurality of plug cavities 608 are arranged in each of the first and second rows 610, 612. In the illustrated embodiment, six plug cavities 608 are arranged in each of the first and second rows 610, 612, thus providing a total of twelve plug cavities 608 in the cassette 20. In an exemplary embodiment, the cassette 20 includes the same number of plug cavities 608 at the rear 606 as the plug cavities 42 (shown in FIG. 2).

The cassette 20 includes a plurality of rear mating connectors 614 aligned with the plug cavities 608. The rear mating connectors 614 are configured to mate with the modular plugs. The modular plugs may be provided at ends of cables that are routed behind the cassette 20 to a network switch, other network component, or another electronic device. The cassette 20 includes the same number of rear mating connectors 614 at the fear 606 as the electrical connectors 106 (shown in FIG. 6). In an exemplary embodiment, the rear mating connectors 614 are electrically connected to corresponding electrical connectors 106, in a one-to-one relationship. As such, the rear mating face of the cassette 20 is substantially similar to the front mating interface of the cassette 20.

FIG. 17 is a cross-sectional view of the cassette 20 illustrating the contact subassembly 100 loaded into the housing 30 and the interface connector 600 loaded into the cover 602. The interface connector 600 includes a rear contact subassembly 620 that is similar to the front contact subassembly 100. FIG. 17 illustrates the circuit board 104, the electrical connector 106 mounted to the rear side of the circuit board 104 and the contact sets 146 and corresponding contact supports 152 extending from the front side of the circuit board 104. The contact sets 146 are arranged in the corresponding plug cavities 42. The electrical connector 106 is a card edge connector and is electrically connected to an interposer board 622 received in the slot of the electrical connector 106. The rear contact subassembly 620 is similarly electrically connected to the interposer board 622. In an exemplary embodiment, the interposer board 622 includes contact pads on different edges thereof, wherein the front contact subassembly 100 and the rear contact subassembly 620 are electrically connected to the contact pads of the interposer board 622.

The rear contact subassembly 620 includes a circuit board 624, a rear electrical connector 626 mounted to one side of the circuit board 624 and a plurality of contact sets 628 and corresponding contact supports 630 extending from the opposite side of the circuit board 624. In an exemplary embodiment, the rear contact subassembly 620 is substantially similar to the contact subassembly 100. Select ones Of the contact sets 628 are electrically connected to corresponding contact sets 146 of the front contact subassembly 100 via the interposer board 622. For example, the electrical connector 626 receives one side of the interposer board 622, and the electrical connector 106 receives the opposite side of the interposer board 622. The front and rear electrical connectors 106, 626 may be electrically connected to contact pads at opposed edges of the interposer board 622.

FIG. 18 is a cross-sectional view of another alternative interface connector 650 and cover 652 for the cassette 20. The cassette 20 includes a front side 654 and a rear side 656. Similar to the interface connector 600 (shown in FIG. 16), the mating interfaces of the front and rear sides 654, 656 are substantially identical.

The interface connector 650 defines a rear contact subassembly having a plurality of contact sets 658 and corresponding contact supports 660 at the rear side 656, in a similar manner as the interface connector 600. However, rather than utilize a second circuit board and electrical connector, as the embodiment described above, the contact sets 658 and corresponding contact supports 660 are directly connected to the rear side of a circuit board 662, which may be similar to the circuit board 104 (shown in FIG. 5). The circuit board 662 includes the contact sets 146 and corresponding contact supports 152 extending from the opposite side as the contact sets 658 and the contact supports 660.

A cassette 20 is thus provided that may be mounted to a panel 12 through an opening 22 in the panel 12. The cassette 20 includes a plurality of modular receptacles 16 that are configured to receive plugs 14 therein. The cassette 20 includes a contact subassembly 100 and an interface connector assembly 120. The contact subassembly 100 is loaded into a housing 30 and the contact subassembly 100 and interface connector assembly 120 are surrounded by the housing 30 and/or a cover 32. The contact subassembly 100 includes contacts 144 that are arranged in contact sets 146 that are loaded into plug cavities 42 defined by the housing 30 when the contact subassembly 100 is loaded into a rear chamber 170 of the housing 30. Walls 160 of the housing 30 define the plug cavities 42 such that the housing 30 defines more than one modular jack 60. The contact subassembly 100 includes a circuit board 104 that provides an interface between the contacts 144 and an electrical connector 106 which is mated with the interface connector assembly 120. The electrical connector 106 is configured to interchangeably mate with different types of interface connectors, having different types of rear mating connectors. For example, the rear mating connectors may define different mating interfaces for mating with different types of back end connectors. In an exemplary embodiment, the interface connectors are pluggably coupled to the contact subassembly such that the interface connectors may be quickly unplugged and replaced with a different interface connector. The interface connectors may be plugged and unplugged while the housing and contact subassembly remain mounted to the panel. As such, the modular plugs do not need to be removed from the cassette when repairing, replacing and/or upgrading the back end of the cassette 20.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A cassette comprising:
a shell having a front and a rear, the shell having a plurality of plug cavities open at the front for receiving plugs therein;
a contact subassembly received within the shell, the contact subassembly having a circuit board with front and rear sides, the contact subassembly having a plurality of contacts electrically connected to the circuit board and extending from the front side, the contacts being arranged in contact sets that are configured to mate with different plugs, and the contact subassembly having an electrical connector extending from the rear side, the electrical connector being electrically connected to corresponding ones of the contacts; and
an interface connector received within the shell, the interface connector being mated with the electrical connector, the interface connector having a rear mating connector extending from the rear of the shell that is configured to mate with a mating connector.

2. The cassette of claim 1, wherein the interface connector includes a circuit board, the rear mating connector being mounted to the circuit board of the interface connector, the circuit board of the interface connector being electrically connected to the circuit board of the contact subassembly by the electrical connector of the contact subassembly.

3. The cassette of claim 1, wherein the interface connector includes a circuit board, the rear mating connector being mounted to the circuit board of the interface connector, the circuit board of the interface connector having contact pads along an edge of the circuit board, the circuit board of the interface connector being received in the electrical connector to electrically connect the contact pads to contacts of the electrical connector.

4. The cassette of claim 1, wherein the interface connector includes a circuit board and an electrical connector mounted to the circuit board, the electrical connector of the interface connector being mated with the electrical connector of the contact subassembly.

5. The cassette of claim 1, wherein the electrical connector of the contact subassembly is interchangeably mated with the interface connector and being interchangeably mated with a second interface connector having a rear mating connector that defines a different mating interface than the rear mating connector of the other interface connector.

6. The cassette of claim 1, wherein the interface connector includes a circuit board, the rear mating connector be mounted to the circuit board of the interface connector, the circuit board of the interface connector being oriented generally perpendicular to the circuit board of the contact subassembly.

7. The cassette of claim 1, wherein the contact subassembly is positioned within the shell such that the circuit board is positioned between the front of the shell and the interface connector.

8. The cassette of claim 1, wherein the electrical connector is electrically connected to the contacts of more than one of the contact sets.

9. The cassette of claim 1, wherein the rear mating connector is electrically connected to the contacts of more than one of the contact sets.

10. A cassette comprising:
a shell defining a plurality of plug cavities for receiving plugs therein; and
a contact subassembly received within the shell, the contact subassembly having a circuit board, a plurality of contacts extending from a front side of the circuit board and an electrical connector extending from a rear side of the circuit board, the contacts being configured to mate with different ones of the plugs, the electrical connector being electrically connected to corresponding ones of the contacts, the electrical connector being configured to interchangeably mate with different types of interface connectors.

11. The cassette of claim 10, further comprising a first interface connector having a rear mating connector of a first type, and a second interface connector having a rear mating connector of a second type different from the first type.

12. The cassette of claim 10, wherein each interface connector has a substantially similar mating interface for mating with the electrical connector.

13. The cassette of claim 10, wherein the electrical connector defines a card edge connector, each interface connector includes a circuit board having contact pads along an edge of the circuit board of the interface connector for removably mating to the electrical connector, a selected one of the circuit boards being plugged into the electrical connector.

14. The cassette of claim 10, wherein each interface connector includes a rear mating connector that defines the type of interface connector, each different type of rear mating connector being configured to mate with a different type of external mating connector.

15. The cassette of claim 10, wherein the shell includes a housing and a cover cooperating to define an inner chamber, the housing defines the plug cavities, the contact subassembly and the interface connector mated with the electrical connector are at least partially received within the inner chamber.

16. The cassette of claim 15, wherein the cover defines an opening, a portion of the interface connector been exposed by the opening for mating with an external mating connector.

17. The cassette of claim 15, further comprising different types of covers corresponding to the different types of interface connectors, the covers being interchangeably coupled to the housing depending on the type of interface connector mated with the electrical connector.

18. A cassette comprising:
a shell having a front and a rear, the shell defining a plurality of plug cavities for receiving plugs therein, the plug cavities defining front plug cavities being arranged at the front and the plug cavities defining rear plug cavities being arranged at the rear;
a front contact subassembly received within the shell, the front contact subassembly having a plurality of contacts arranged in each of the front plug cavities and being configured to mate with different ones of the plugs at the front of the shell;
a rear contact subassembly received in the shell, the rear contact subassembly having a plurality of contacts arranged in each of the rear plug cavities and being configured to mate with different ones of the plugs at the front of the shell; and
at least one circuit board arranged between the contacts of the front and the rear contact subassemblies, the contacts of the front contact subassembly being electrically connected to corresponding contacts of the rear contact subassembly via the at least one circuit board.

19. The cassette of claim 18, wherein the shell and the front and rear contact subassemblies cooperate to define substantially identical mating faces at the front and at the rear of the shell.

20. The cassette of claim 18, wherein the at least one circuit board comprises a front circuit board and a rear circuit board, the contacts of the front contact subassembly being directly connected to the front circuit board, the contacts of the rear contact subassembly being directly connected to the rear circuit board, a front electrical connector being electrically connected to the front circuit board, a rear electrical connector being electrically connected to the rear circuit board, the front and rear electrical connectors being electrically connected to one another.

21. The cassette of claim 18, further comprising an interposer board having contact pads at two edges thereof, wherein the front and rear electrical connectors both define card edge connectors receiving different edges of the interposer board and being electrically connected to the contact pads of the interposer board.

22. The cassette of claim 18, wherein the contacts of the front and the rear contact subassemblies are directly connected to the same circuit board.
